(19) United States
(12) Patent Application Publication
(10) Pub. No.: US 2025/0305611 A1
(43) Pub. Date: Oct. 2, 2025

(54) GRIPPING ELMENTS PRODUCED WITH CONTROLLED HARDNESS FOR SEALING AND RESTRAINT SYSTEMS USED IN FLUID PIPELINES

(71) Applicant: S & B Technical Products, Inc., Fort Worth, TX (US)

(72) Inventor: Mark A. Weih, San Jose (CR)

(73) Assignee: S & B Technical Products, Inc., Fort Worth, TX (US)

(21) Appl. No.: 18/624,800

(22) Filed: Apr. 2, 2024

(51) Int. Cl. F16L 37/091; B22F 3/10; B22F 3/20

(52) U.S. Cl. CPC F16L 37/091; B22F 3/1021; B22F 3/20; B22F 2301/35

(57) ABSTRACT

A method is shown for manufacturing a hardened gripping element for a sealing and restraint system used for forming a pipe joint in a fluid pipeline. Instead of machining the gripping elements used in the system from a metal stock, a special series of metal injection molding steps are utilized. A metal polymer composite mix is first formed having a metal particulate phase and a polymer phase. A green metal composite article is formed by either extruding the composite mix or molding the composite mix into a metal polymer composite article having at least one gripping surface having a plurality of gripping teeth. The green composite article is subjected to thermal debinding and sintering to produce a brown part. The brown part is selectively hardened in the range from about 42 HRC to 45 HRC to produce a finished or near finished hardened gripping element.

### BACKGROUND OF THE INVENTION

### 1. Field of the Invention

The present invention relates generally to a method for producing gripping elements for sealing and restraint systems used to seal fluid pipelines such as those used in the waterworks industry and, more particularly, to method for producing such gripping elements having MIM teeth with a controlled, critical hardness.

### 2. Description of the Prior Art

Pipes are commonly used for the conveyance of fluids under pressure, as in city water lines. They may also be used as free-flowing conduits running partly full, as in drains and sewers. Pipes for conveying water in appreciable quantities have been made of steel, cast iron, concrete, vitrified clay, and most recently, plastic including the various polyolefins and PVC.

It is well known in the art to extrude plastic pipes in an elongated cylindrical configuration of a desired diameter and to then cut the extruded product into individual lengths of convenient size suitable for handling, shipping and installing. Each length of pipe is enlarged or “belled” at one end sufficiently to join the next adjacent pipe section by receiving in the female, belled end the unenlarged or “spigot” male end of the next adjacent length of pipe. The inside diameter of the bell is formed sufficiently large to receive the spigot end of the next section of pipe with sufficient clearance to allow the application of packing, caulking, elastomeric gaskets or other sealing devices designed to prevent leakage at pipe joints when a plurality of pipe lengths are joined to form a pipeline.

In the early 1970's, a new technology was developed by Rieber & Son of Bergen, Norway, referred to in the industry as the “Rieber Joint.” The inventions related to this sealing system were developed by Gunnar Parmann, a Norwegian engineer. The Rieber system provided an integral sealing mechanism within the belled or female pipe end for sealing with the spigot end of a mating pipe formed from thermoplastic material. In the Rieber process, the elastomeric gasket was captured within an internal groove in the socket end of the female pipe as the female or belled end was simultaneously being formed. The sealing gasket was “belled in place”, in contrast to earlier systems in which the pipe belled end was pre-formed at the factory with an internal groove or raceway, and the sealing gasket was later installed, as by hand. The provision of a prestressed and anchored elastomeric gasket during the belling process at the pipe factory provided an improved socket end for a pipe joint with a sealing gasket which would not twist or flip or otherwise allow impurities to enter the sealing zones of the joint, thus increasing the reliability of the joint and decreasing the risk of leaks or possible failure due to abrasion. The Rieber process is described in the following issued United States patents, among others: U.S. Pat. Nos. 4,120,521; 4,061,459; 4,030,872; 3,965,715; 3,929,958; 3,887,992; 3,884,612; and 3,776,682. While the Rieber process provided an improved sealing system for plastic pipelines of the type under consideration, it did not include any integral restraint type mechanism.

However, in addition to the sealing mechanism, there is also a need in many circumstances for a restraint mechanism of some type in fluid pipe joints. In the case of municipal installations, the joints between pipes and between pipes and fittings are often restrained to accommodate varying pressures as well as environmental influences. For example, there are various types of connection mechanisms which are commercially available and which are used in, for example, the waterworks industry. In one type of connection, used for many years, the restraint mechanism was an external clamping device which is totally separated from the sealing function. Thus, a separate mechanism must perform the sealing function. However, it was necessary that an external structure be used to compress the gasket by mechanical action such as T-bolts. These type of joint restraint systems were cumbersome to install and represented a substantial additional effort for the contractor.

Because of these disadvantages, the newer generation of sealing and restraint systems utilize self-restraining joint devices that are internal to the piping system and allow for better corrosion protection of the metal components, as well as better and less time consuming installation procedures. One example is the system known in the industry as the Bulldog® system and is described in U.S. Pat. No. 7,284,310, issued Oct. 23, 2007, to Jones et al., and in other related patents. In this system, the restraining and sealing mechanism includes a circumferential housing and a companion sealing ring which are received within a mating groove provided in the belled end of a female pipe. The circumferential housing has an interior region which contains a gripping ring insert. The sealing ring and housing are integrally located within a belled pipe end during belling operations. The ring-shaped gripping insert is made of metal.

There are a variety of other sealing and restraint systems present in the marketplace and currently under development. In some cases, rather than utilizing a circumferential, ring-shaped gripping insert, the gripping mechanism utilizes more discrete “segments” sometimes formed in the rubber of the sealing gasket, the segments having serrations or steel teeth-like structures. With either the gripping ring or gripping segments, the steel-teeth structures allow only for an entry movement of the male spigot pipe end into the female belled pipe end in making up a pipe joint. Any opposite movement of the spigot causes the teeth to sink into the exterior surface of the pipe, creating a sealing pressure which can withstand and counterbalance commonly encountered thrust forces in field use, thus holding the pipe joint in place and preventing separation. However, in all cases, the gripping inserts need to be sharp and durable, typically of relatively high density, be corrosion resistant and have a high tensile strength. In the past, the production of such items has been reserved for high quality metal materials, such as stainless steel. Also, these structures need to have very accurate part dimensions.

Accordingly, there is a need for a cost-effective, simple to manufacture and simple to use combination seal and restraint system for restraining and sealing plastic pipe against internal and external forces at a pipe or fitting connection and for joining and sealing at least two plastic pipes at a pipe joint to form a secure fluid pipeline, as well as for ductile iron pipe with gaskets containing stainless steel segments.

A need also exists for such a seal and restraint system which incorporates gripping elements made using an improved manufacturing process with a desired degree of hardness which provides improved material properties such as density, yield strength, tensile strength and elongation which is no more expensive than currently available techniques.

### SUMMARY OF THE INVENTION

The present invention relates to the fabrication of high quality, durable, flexible and strong plastic pipe joint structures, with different types of gripping inserts. For example, the inserts might be heavy, dense hard grip rings or dense, hard, serrated joint inserts for pipeline joints used in the waterworks industry, or other ancillary industrial applications such as in the oil and gas industries where fluid pipelines are used. The gripping inserts of the invention are produced with a much higher weight, at much lower production costs and energy consumption requirements and with less wear on the production equipment than the state of the art technology allows.

Using the new manufacturing techniques, whole sealing gaskets can be produced with both larger metallic inserts and smaller serrated structures for internal joint systems in fluid pipeline applications. Special metal injection molding (MIM) techniques are utilized in the manufacturing process which have, to Applicant's knowledge, not been used before in the waterworks industry for gripping and sealing components. These special MIM techniques have a number of unique attributes. The resulting gripping structures or elements produced with these techniques are heavier structures with better dimension control, density and structural properties than has been achieved in the past in the particular industries of concern. In the area of fluid pipelines, particularly plastic pipelines, the result is a less expensive sealing and restraint joint structure with heavy elements that are high density, hard, sharply serrated and durable and which are also produced with less material and process costs than using lost wax, investment casting, or press and sinter manufacturing methods. There is less equipment wear and more reliable density, as well as more dimensional control in the final product dimensions than the current state of the art products.

Current state of the art metal injection molding techniques used in other industrial processes are complicated and typically result in an almost 20% shrinkage rate between the green part (fresh out of the mold) and the brown, sintered part (after the sintering process is over). This high shrinkage leads to poor dimensional control which often leads to structural uncertainties and even part failure during sintering, consequently the size of the brown sintered parts has generally been limited to a few hundred grams.

However, the techniques used in making the parts of the invention allow for the manufacture of gripping elements which are much larger in size. In one aspect, the new molding techniques, to be described hereafter, make use of a metal-polymer composites made according to what will be referred to in the description which follows as “the Tundra® Technology.” As will be further described, the composite mixtures made according to the Tundra® Technology allows for an outstanding dimension control of the final product, resulting in a shrinkage between the green product and the brown product of less than 10% by weight after sintering. This is a 200% better dimensional control than the current state of the art technology achieves. As a result, not only are very accurate parts obtained, with no need for machining or sharpening as required with other casting methods, but with very sharp teeth which meet or exceed specifications, but it is also possible to produce very heavy parts, up to six times what current technological standards achieve. This low shrinkage ratio means that the green part is basically near final shape and allows the serrated products to retain an outstanding tooth sharpness. As mentioned, metal injection molding (MIM) has previously been reserved for products smaller than about, for example, 200 grams. Current state of the art does not generally allow for larger parts due to the poorly controlled and very pronounced shrinkage which causes distortion and fracturing during the sintering process.

In addition to the use of special MIM processes and products, the present invention involves the further discovery that an improved sealing and restraint system can be provided for fluid pipe lines which incorporates gripping elements having a desired degree of hardness, within a selected hardness range, which provides improved material properties such as density, yield strength, tensile strength and elongation. Selective metal hardening is used following the sintering step which results in gripping teeth which exhibit considerably better cyclic life under loading, while also exhibiting the required gripping performance, as compared to that of the originally specified harness for such materials. By manufacturing gripping segments made at approximately 8-10 and preferably 4-5 points lower hardness than presently used practice, greatly improved results are obtained.

A preferred range of hardness is in the range from about 34 HRC to 45 HRC, and a particularly preferred range is 42-45 HRC after sintering. This is to be compared to the state of the art practice of hardening in the range from about 49 HRC to 53 HRC. In cyclic testing, gaskets made with MIM produced teeth made according to the existing state of the art processing techniques withstood on the order of 400-1000 cycles of testing under a 0 to 350 PSI cyclic load without fracturing. By comparison, teeth made with the selective hardness of the inventive process have been found to last up to 25,000 cycles, or more, under a 0 to 350 PSI cyclic load, without fracturing. Additionally, MIM teeth produced according to the existing state of the art fractured under a 20,000 lb compressive load, while the selectively hardened MIM teeth withstood the 20,000 lb load without fracturing.

In the most basic form, the process for producing the improved gripping elements of the invention includes at least the steps of (1) injection molding or extruding a green part gripping element from an MIM feedstock; (2) thermally or catalytically debinding and sintering the green part (which may be combined into one step, or may be two steps) to produce a brown part; hardening the brown part, the hardening step being carried out to achieve adaptive hardening of the gripping teeth by hardening within a selected range, the range preferably being from about 42 HRC to about 45 HRC.

In one preferred form, the process of the invention uses a Tundra® plasticized feedstock. In another preferred form, a different starting feed stock is used. With the Tundra® plasticized feedstock, the detailed process steps of the invention can be described in the following steps:
1. Creating a 3D printed metallic mold of the part that will be fabricated, or machining the mold by conventional methods.
2. Injection molding of the Tundra® plasticized feedstock with the aid of an injection molding machine.
3. Thermally debinding and sintering of the green part to produce a brown part, combined in one step in an industrial oven, or performed in two steps, to produce a brown part.
4. Selective hardening of the brown part, to achieve a final hardness in the range from about 34 HRC to about 45 HRC, and preferably 42-45 HRC.
5. Performing minimum finish machining if needed to obtain the final part.
6. Incorporating the finished part into the pipe sealing and restrained joint system for PVC or ductile iron.

The gripping elements can be incorporated into a sealing and restraint system which is, for example, used in the waterworks industry to form sealing pipe joints in water or sewer pipelines. In its preferred form, a pipe sealing gasket is shown which is designed for receipt within a raceway provided within a female bell socket end of a ductile iron, PVC, or PE pipe. With the present technology, a single segment can be produced for all three types of pipe systems. The hardened gripping elements which are formed according to the teachings of the invention are incorporated into the gasket, or form part of a companion restraint system which cooperates with the sealing gasket in forming a sealed and restrained joint for the fluid pipeline.

Additional features and advantages will be apparent in the written description which follows.

### BRIEF DESCRIPTION OF THE DRAWINGS

FIG. 1 is a side, partial cross sectional view of a pipe joint formed using sealing and restraint elements formed according to the manufacturing principles of the present invention.

FIG. 2 is an isolated, perspective view of the sealing and restraint element used in the pipe joint of FIG. 1.

FIG. 3 is a view, similar to FIG. 1, of another pipe joint using sealing and restraint elements formed according to the manufacturing principles of the invention.

FIG. 4 is a partial, sectional view of the sealing and restraint system of the pipe joint of FIG. 3.

FIG. 5 is a perspective view, partly broken away, of a ductile iron fitting having a sealing and restraint system with hardened gripping elements formed according to the principles of the invention.

FIG. 6 is a partial sectional view of another sealing and restraint system using the hardened gripping elements of the invention with a segmented grip ring.

FIG. 7 is a graph of heat treatment response versus Rockwell C Hardness for gripping teeth made according to the process of the invention.

### DETAILED DESCRIPTION OF THE INVENTION

The preferred version of the invention presented in the following written description and the various features and advantageous details thereof are explained more fully with reference to the non-limiting examples included and as detailed in the description which follows. Descriptions of well-known components and processes and manufacturing techniques are omitted so as to not unnecessarily obscure the principal features of the invention as described herein. The examples used in the description which follows are intended merely to facilitate an understanding of ways in which the invention may be practiced and to further enable those skilled in the art to practice the invention. Accordingly, the examples should not be construed as limiting the scope of the claimed invention.

As has been briefly discussed, the hardened gripping elements formed using the manufacturing techniques of the present invention can find wide applicability as components of sealed pipe joints in the waterworks industry and other industries. The discussion which follows will focus primarily on sealed and restrained pipe joints of the type used, for example, in the fluid flow pipelines used in municipal water lines and sewer lines. However, it should be understood that the joint structures to be described could also find applicability in other industrial areas, such as in fluid pipelines used in the oil and gas industry, various chemical process industries, and the like. The improved manufacturing processes described herein may also find applicability to other MIM products and processes.

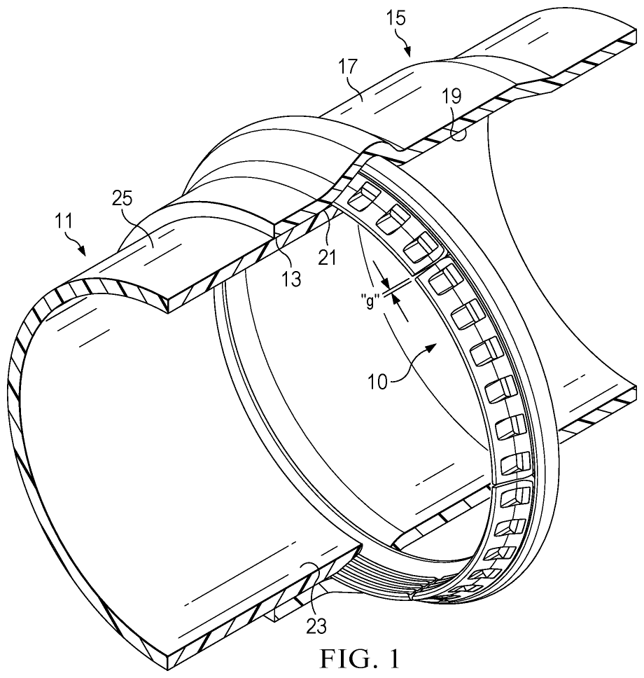

One example of a finished sealing and restraint mechanism of the type under consideration will now be described, by way of example. With reference to FIG. 1, there is shown, in quarter sectional fashion, a male or spigot pipe end 11 of one section of PVC-O pipe about to be inserted into the mouth or end opening 13 of a socket or bell pipe end 15 of a second, female mating section of PVC-O pipe of the type used in the waterworks industry. The female pipe section 15 has an exterior surface 17, an interior surface 19 and having an interior circumferential recess or groove 21, sometimes referred to as a “raceway” formed in the belled pipe end adjacent the mouth opening on the interior surface thereof. The circumferential groove or raceway 21 is formed during the manufacture of the plastic pipe. Thereafter, a sealing and restraining gasket 10 is installed within the raceway. It will be understood by those skilled in the relevant arts that the gasket could also be of the type which is installed integrally with the formation of the raceway in the female, belled pipe end, as in a Rieber style pipe manufacturing process.

The mating male section of plastic pipe or spigot 11 has an interior surface 23 and exterior surface 25. In the view shown in FIG. 1, the male pipe section 11 is beginning the insertion step within the mouth opening of the female pipe section 15 to form a sealed pipe joint.

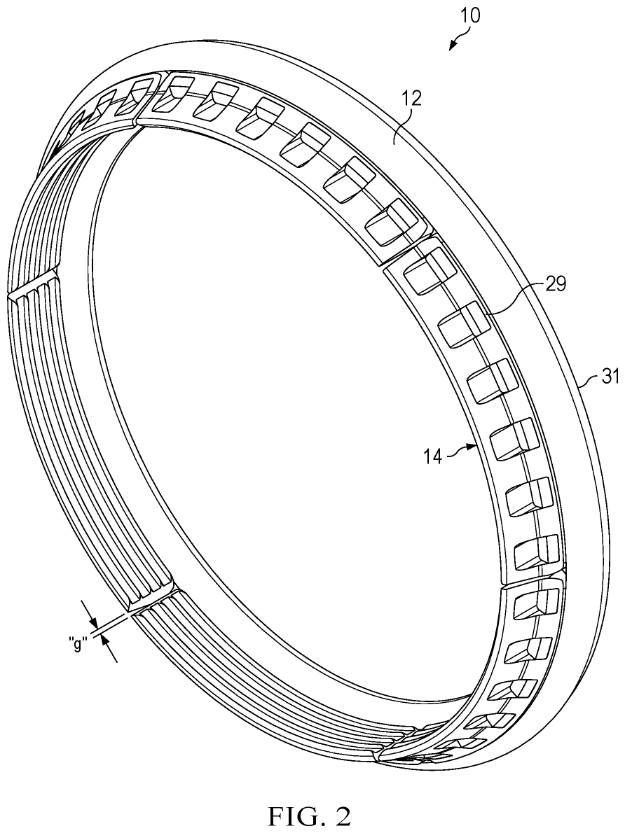

The sealing and restraint gasket 10 is shown in perspective in FIG. 2 of the drawings. The sealing and restraint element 10 is comprised of an inner ring-shaped elastomeric body 12 joined to a series of hardened arcuate gripping segments (such as segment 14 in FIG. 2). The ring-shaped elastomeric body 12 has an inner circumferential region 29 and an outer circumferential region 31, the outer circumferential region being arranged to form a seal with the interior surface of the belled end of the female pipe section while the inner circumferential region forms a sealing surface for the exterior surface of the mating male pipe section.

The elastomeric portion 12 of the sealing and restraint system of the invention provides the primary sealing capacity for the pipe joint. The main rubber portion of the gasket can be, for example, styrene butadiene rubber (SBR), ethylene propylene diene rubber (EPDM), acrylonitrile-butadiene rubber (NBR), nitrile rubber, etc., and the manufacture of such sealing bodies is well known by those skilled in the relevant arts. The Durometer of the rubber used will vary according to the end application but will generally have a Shore A hardness in the range from about 40 to 65.

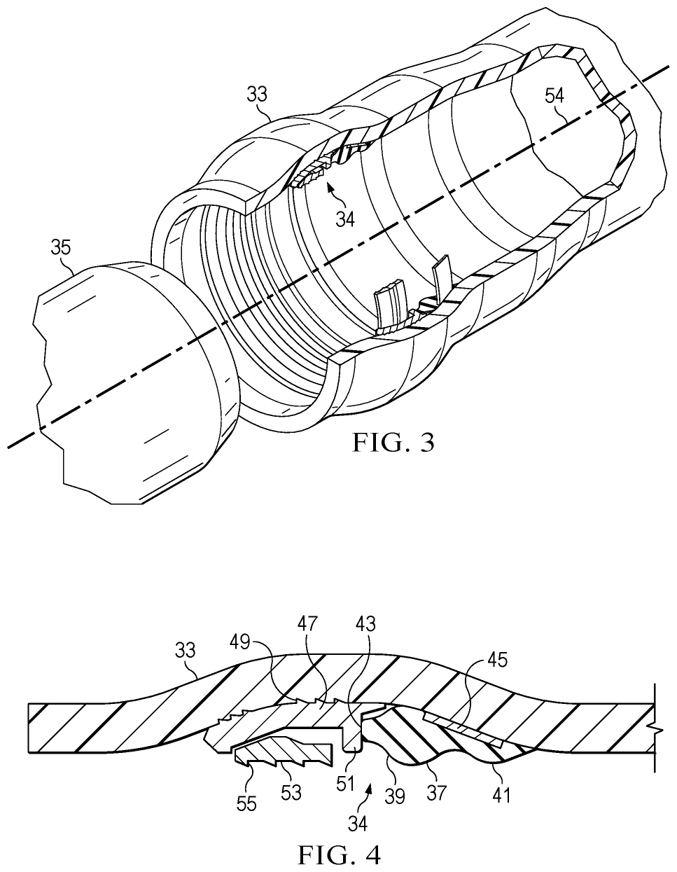

The gripping segments 14 (FIG. 2) are typically formed of a metal such as iron or a steel, such as stainless steel. Examples include 316 which is a nitride, 410, 420, or 431, which are thermally hardened, 17-4 which is thermally hardened, and even Inconel which is thermally hardened. The number of gripping segments will vary depending upon the diameter of the sealing and gripping assembly. For the example of FIG. 3 where the annular gasket body 12 has an eight inch diameter, six separate gripping segments 14 are shown extending outwardly around the circumference of the gasket body. The gaps “g” between the metallic gripping segments 14 provide some degree of flexibility for the assembly, thereby facilitating its installation within the mouth region of the female pipe section.

While the sealing and restraint system shown in FIGS. 1 and 2 uses a hardened gripping element which is combined with or an integral sealing element, it is also possible that the hardened gripping elements could be separate from, but associated or cooperative with the sealing element of the system. FIGS. 3 and 4 show such a sealing and restraint system in which the hardened gripping elements are separate, again in a sealing and restraint system for plastic pipe.

FIG. 3 is an exploded view of a plastic pipe joint in which a belled female pipe end 33 is provided with an annular groove for receiving the sealing and restraint system, designated generally as 34 in FIGS. 3 and 4. The system shown is sold commercially as the Bulldog® Sealing and Restraint System by the assignee of the present invention, and others. The integral sealing and restraint system shown is capable of joining and sealing the female plastic pipe end 33 to the spigot end 35 of a mating male plastic pipe section. The plastic pipe male and female ends can be made from any convenient synthetic material including the polyolefins such as polyethylene and polypropylene but are preferably made from polyvinyl chloride (PVC). However, it will be understood by those skilled in the relevant arts that the male pipe or spigot can also be made from ductile iron.

As best seen in FIG. 4, the sealing and restraint system includes an elastomeric, circumferential sealing ring 37 which is formed as an elastomeric body. The annular sealing ring 37 is somewhat tear drop shaped in cross section and includes a bulbous end region 39 and a thinner forward most region 41. The bulbous end region 39 terminates in a nose portion 43. The sealing portion of the gasket contacts the exterior surface of the mating male pipe section upon assembly of the joint. The sealing member is preferably made of a resilient elastomeric or thermoplastic material. In the particular case shown, the sealing ring 37 has a metal reinforcing band 45 about the outer circumference thereof. However, any number of specialized sealing rings can be utilized in order to optimize the sealing and restraining actions of the assembly.

The seal portion of the assembly also includes a companion restraining mechanism which allows movement of the mating male pipe relative to the belled end of the female pipe 33 in a first longitudinal direction but which restrains movement in a second, opposite relative direction. In the particular case shown, the companion restraining mechanism includes a ring shaped housing 47. The ring shaped housing provides radial stability and reinforcement for the male (spigot) pipe end 35 during makeup of the joint. Although the housing could have a circumferential opening, it is preferably provided as a solid ring of a slightly larger internal diameter than the forming mandrel where a Rieber style manufacturing process is used to integrally install the housing during manufacture of the pipe joint. Alternatively, the housing could be used with some form of collapsible forming mandrel, in which case its internal diameter might approach or exceed that of the mandrel in certain of its states of operation.

The exterior of the housing may be equipped with one or more rows of gripping teeth 49 for engaging the surrounding pipe groove. The corresponding grooves or indentations in the pipe interior may be formed during the belling operation as the pipe cools. The ring shaped housing 47 is preferably formed of a material selected from the group consisting of metals, alloys, elastomers, polymeric plastics and composites and is rigid or semi-rigid in nature. The housing external shoulder 51 is substantially perpendicular to the longitudinal axis 54 of the female pipe. The external shoulder 51 is in contact with the nose region of the elastomeric body of the sealing ring 37 as the mating male pipe is inserted into the mouth opening of the female belled pipe end 33.

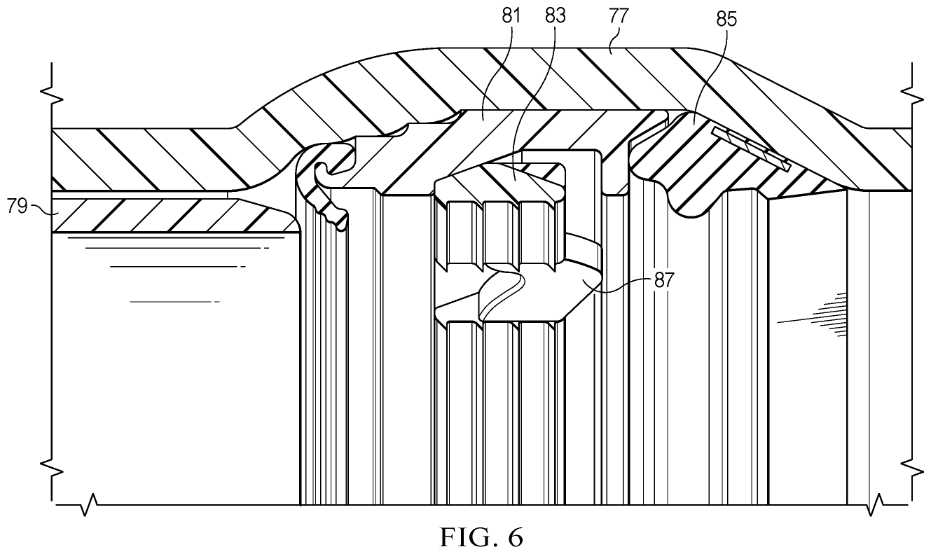

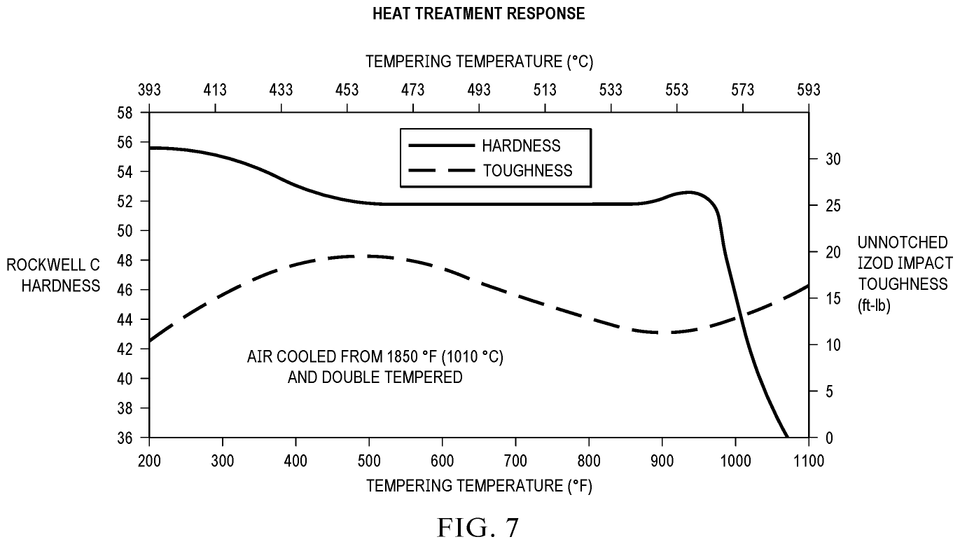

The housing 47 used in the sealing and restraining system of FIGS. 3 and 4 also includes a companion ring-shaped gripping insert 53 which is manufactured according to the principles of the invention and which is received in complimentary fashion and contained within the circumferential interior region of the housing 47. The gripping insert 53 is a ring shaped body which as at least one row of gripping teeth 55 on an interior circumferential surface thereof. As will be described further with respect to FIG. 6, the gripping insert 53 could also assume the form of a segmented grip ring. In the version of the restraining system shown in FIG. 4, the gripping insert has four rows of teeth. The rows of teeth are arranged for engaging selected points on the exterior surface of the mating male pipe section 35. Contact with the exterior surface of a mating male pipe causes the gripping insert 53 to ride along the male pipe exterior surface at an angle while the row of gripping teeth 55 on the gripping insert internal surface engage the exterior surface of the mating male pipe.

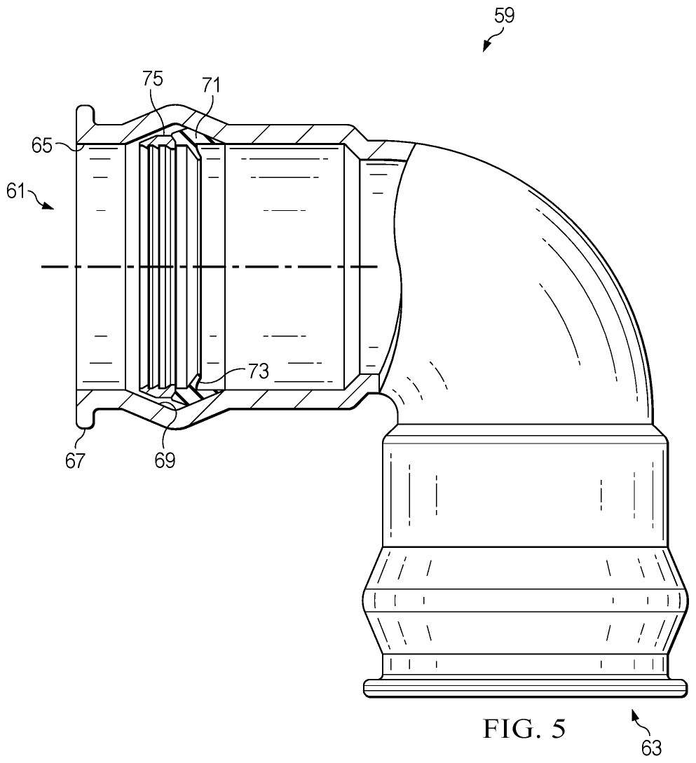

While the sealing and restraint systems illustrated thus far have dealt primarily with joints between sections of plastic pipe, the hardened gripping elements which are the subject of the invention also have equal applicability in ductile iron piping systems. FIG. 5 shows a prior art sealing and restraint system for an as-cast ductile iron fitting, designated generally as 59. The as-cast fitting 59 has opposing end openings 61, 63. Each end opening has an adjacent mouth region (65 in FIG. 5) and can be provided with a slight upset 67. An annular groove 69 is provided within the mouth region 65 slightly spaced back from the end opening 61.

The combination sealing and restraint system for the ductile iron system shown in FIG. 5 also includes an annular gasket body 71 installed in the annular groove 69 provided in the mouth region 65 of the as-cast fitting so that the outer circumferential region of the gasket forms a seal with the fitting mouth region and the inner circumferential region thereof forms a sealing surface for a mating male pipe section. The lip region 73 of the inner circumferential region forms a primary lip seal for engaging the mating male pipe end during insertion. As seen in FIG. 5, the sealing and restraint system also includes a series of spaced, hardened gripping elements 75 which can be replaced with the gripping elements made by the process of the invention.

FIG. 6 shows one other alternative sealing and restraint system, in this case for a plastic pipe female socket member 77 and male spigot member 79. The particular sealing and restraint system includes a ring-shaped casing 81 which comprises a single piece, ring formed of a suitable metal or of a plastic which is integrally installed within the female, belled pipe end. The ring shaped casing 81 has a circumferential interior region for receiving a companion segmented grip ring (83 in FIG. 6). The casing 81 and grip ring 83 form a companion restraint mechanism for an elastomeric sealing ring 85 which allows movement of the mating male pipe 79 relative to the belled end of the female pipe 77 in a first longitudinal direction, but which restrains movement in a second, opposite relative direction while also providing sealing integrity for the pipe joint. The components of the sealing and restraint system shown in FIG. 6 show the components before assembly to make up the pipe joint.

The sealing and restraint system shown in FIG. 6 differs from the other systems shown in that the grip ring 83 is “segmented” instead of being a continuous ring or spaced gripping elements or segments. Instead, the segmented grip ring 83 has solid gripping elements (such as element 83 in FIG. 6) connected by discrete elastomeric segments 87. The elastomeric segments 87 act as a “wave spring” in use to hold the gripping segments 83 in the upper beveled portion of the casing 81, allowing easier insertion without interference with the spigot. The elastomeric segments 87 also compress and fill the lower part of the casing 81, springing back when the load is released.

In all of the cases discussed above, the gripping inserts (such as ring 53 in FIG. 4 or elements 83 in FIG. 6) were, in the past, formed of a hard metal, such as corrosion resistant stainless steel, or from other metallic materials or alloys. It was generally necessary to machine the gripping inserts from bar stock, or the like. Unlike the prior art methods, the method of manufacturing hard gripping elements of the invention involves a metal injection molding or extrusion process.

In its most elemental form, the method involves the steps of:
providing a metal polymer composite mix, the composite comprising a metal particulate phase and a polymer phase;
forming a green metal composite article by either extruding the composite mix or molding the composite mix into a metal polymer composite article having at least one gripping surface having a plurality of gripping teeth; and
thermally debinding and sintering the green metal composite article in an industrial oven to produce a finished or near finished hardened gripping element (brown part), where the thermally debinding and sintering of the green part may be performed in one or two steps,
and wherein the sintering step is followed by a hardening step which uses adaptive metal hardening of the brown part within a particular, selected range to achieve a final hardness in the range from about 42 HRC to about 45 HRC.

One type of MIM material used as a starting material in the process is described herein as the Tundra® Technology, although it should be understood that other starting MIM materials might be used as well. The second example in the discussion which follows uses a different commercially available MIM material. By “MIM material” is meant a metal working process in which finely-powdered metal is mixed with binder material to create a “feedstock” that is then shaped and solidified, as by using injection molding techniques. The molding process allows high volume, complex parts to be shaped in a single step. After molding, the part undergoes conditioning operations to remove the binder (debinding) and densify the powders. The general steps used in the process will be familiar to those skilled in the relevant arts. The process is used today in many different industries and applications.

### The Tundra® Technology:

The method of the invention is enabled in one form by utilizing a new metal injection molding (MIM) technology developed by Tundra Composites, LLC, which is described, for example, in issued U.S. Pat. No. 9,512,544, issued Dec. 6, 2016, to Heikkila, and in issued U.S. Pat. No. 10,328,491, issued Jun. 25, 2019, to Heikkla, as well as in other references. The enabling technology which is described therein will be referred to in the discussion which follows as using “interfacially modified particulate and polymer composite materials” as described in the “Tundra® patents.”

The interfacially modified particulate and polymer composite materials described in the Tundra® patents can be used in injection molding processes, such as metal injection molding and additive process such as 3D printing. These unique materials are especially well adapted for powder metallurgy processes. Improved products are provided under process conditions through surface modified powders that are produced by extrusion, injection molding, additive processes such as 3D printing, press and sinter, or rapid prototyping.

For purposes of the discussion which follows, the following terms will have the meanings described below:

### Binder:

For the powder injection molding, metal injection molding or additive manufacturing techniques described herein, the particulate material such as metal particulates are mixed with other materials such as organic substances. These organic substances are, such as for example polymers, are referred to generally as “binders”. The use of polymer as a binder varies according to the processing method and the particulate mixture. Binders give the green body a sufficient strength by associating particles at their boundary surfaces. Usually those binders are used as plastification agents. They make possible the flow of the particulate during processes such as extruding, injection molding, and additive manufacturing.

Binder systems include thermoplastic systems of the type originally developed for injection molding machines in the plastics industry. Thermoplastic systems are exemplified, for example, by paraffin, wax, polyolefin wax materials; thermoplastic resins such as polyolefin, polypropylene (PP), polyethylene (PE), polyacetal, polyoxymethylene (POM). Molecular chains of polyolefin thermoplastic, polypropylene (PP) and polyethylene (PE) resins are much longer than those of waxes. This difference arises in higher binding forces of thermoplastics and as a consequence a higher melting viscosity and melting point.

### Debinding:

Before sintering green bodies, the debinding process of the polymers must be performed. The removal of the binder is via degradation, extraction or evaporation via the surface channels in the green body. Debinding the part may be done via thermal, solvent or catalytic methods. Binder material is chosen, at least in part, based on the selection of the debinding method. The composite material of the embodiment, comprising particulate that is coated with interfacial modifier, improves the debinding process by allowing debinding to proceed more quickly and efficiently than particulate that is uncoated. The higher volume or weight fractions of the coated particulate permits the use of less binder in the part or object, and the rheology and melt flow of the composite material provide for the part or object to be more quickly formed. Such higher particulate fractions are not possible with uncoated particulate.

The temperatures for thermal debinding generally vary between 60° C. and 600° C. Organic polymers have to be removed completely from the green body, since carbon delays and can influence the sintering process. Further the qualities of the final product can be negatively impacted by residual carbon from the polymer.

### Sintering:

“Sintering is the process whereby particles bond together typically below the melting point by atomic transport events. A characteristic feature of sintering is that the rate is very sensitive to temperature. The driving force for sintering is a reduction in the system free energy, manifested by decreased surface curvatures, and an elimination of surface area. The interfacial modifier on a particle surface may cooperate in the sintering process to the level of fusing with other interfacial modifier coatings on other particles to form the sintered product. The interfacial modified surfaces that fuse or sinter may be the same or different relative to the organo-metallic interfacial modifier. Further, the grain boundary, the interface between particles, may fuse or sinter as well.

### Hardening:

After sintering the green bodies to produce a brown body, the brown body is subjected to a further hardening step or steps, as will be more fully described hereafter.

### Three Dimensional (3D) Printing:

Additive manufacturing or “3D printing” is a manufacturing process for making a three-dimensional solid object of virtually any shape from a digital model. 3D printing is achieved using an additive process, where successive layers of material are laid down in different shapes. 3D printing is considered distinct from traditional machining techniques, which mostly rely on the removal of material by methods such as cutting or drilling (subtractive processes). A materials printer usually performs 3D printing processes using digital technology. The 3D printing technology is used for both prototyping and distributed manufacturing. The technology was developed in the late 1980s and was commercialized in the 1990s.

### The Method of the Invention:

The use of the previously described Tundra composites in manufacturing a gripping element of the invention will now be described. The method of the invention utilizes a metal composite body which, in one form, is formed by an extrusion process at a suitable temperature and shear rate to form an extruded metal composite body having a required density and shrinkage characteristics. In one preferred form, the metal composite body is formed by molding using either a compression molding or injection molding process. The metal particulate phase is made up of particles having a given density and size distribution and wherein an interfacial modifier material is also added to form the composite mix, as has been described in the Tundra® patents. In one preferred embodiment of the invention, the particles are formed of stainless steel and the polymer phase is comprised of a polyolefin polymer such as polypropylene. The metal particulate phase makes up about 50 to 95% by volume of the particulate mix, most preferably about 74% by volume or greater.

The preferred method of the invention, as has briefly been described in the Summary of the Invention, will typically include at least the following process steps:
1. Creating a 3D printed metallic mold of the part that will be fabricated, or manufacturing a mold by normal machining methods,
2. Injection molding of the plasticized feedstock (for example, Tundra® Dynamic LS-316L-02), D-LS 420-02-T, or Dynamic 17-4 Experimental with the aid of an injection molding machine.
3. Thermally debinding and sintering of the green part to produce a brown part, combined in one step in an industrial oven, or performed in two steps
4. Selective hardening of the brown part, to achieve a final hardness in the range from about 34 HRC to about 45 HRC, preferably 42-45 HRC.
5. Performing minimum finish machining if needed to obtain the final part.
6. Incorporating the finished part into the pipe sealing and restrained joint system.

The finished part may then be incorporated into the pipe sealing and restrained joint system of the type previously described.

The following example is illustrative of the steps involved in one preferred embodiment of the invention where the starting material is a Tundra® composite MIM material.

### Example I: Production of Prototypes with a Composite of 96 wt % 420 Stainless Steel with 4% Polypropylene

A composite obtained from Tundra® Composites, LLC, White Bear Lake, Minnesota, (Tundra® Dynamic LS-420-01 with 96 wt % 420 stainless steel) is used as a starting material. The composite is injection molded into a green part, as by utilizing a Haixing Plastic Molding Machine, with a theoretical shot volume of 135 cm³, gross power of the machine of 19 KW and 440 V and 60 Hz.

It is injected with an injection temperature profile of 175,° 180,° 185,° 200° C. from the base of the screw to the juncture of the mold. The mold has a temperature of 80° C. and the packing pressure is 110 bar, with a packing time of 10 seconds.

To accomplish the debinding step, the green parts were preconditioned for 44 hours in a forced convection oven at 135 C to achieve weight loss greater than 1% of part weight (>50% of polymer phase).

The parts were then sintered at a temperature of about 1200° F. An exemplary sintering procedure is:
Ramp 5° C./min to 600° C.
Hold 60 min
Ramp 5° C./min to 1100° C.
Hold 60 min
Ramp 1° C./min 1375° C.
Hold 180 min
Cool 3.5° C./min to room temp
400 cc/min of Ultra High Purity N2 in a 2″ tube furnace.

The parts are then hardened to the desired Rockwell C hardness. In one case, this was accomplished, as follows:
Vacuum Heat Treated at 1950° F. for 2.5 Hours at Heat
Nitrogen Gas Quenched
Tempered at 300° F. for 4 Hours at Heat
Deep Frozen
Re-tempered at 300° F. for 4 Hours at Heat

The hardened brown parts are then lightly machined to produce the final parts.

As has been briefly discussed, starting from the same metal formulation (such as SS 420), hardness levels of 58-59 HRC or even higher, can be achieved by means of suitable heat treatment. However, Applicant has discovered that, when done this way, the gripping teeth which are produced at the specified hardness are relatively brittle and show a short cycle loading life.

It has been found in the practice of the present invention, that if the segments are made at approximately 8-10, preferably 4-5 points lower in hardness, the teeth exhibit considerably better cyclic life with acceptable gripping performance (compared to that of the originally specified hardness). With lower hardness, the teeth are too soft and do not grip ductile iron.

FIG. 5 is a graph of heat treatment response showing Rockwell Hardness versus tempering temperature. Note where the hardness and toughness curves cross at about 44 HRC.

Although not wishing to be bound by any particular theory, one possible theory behind this behavior is that relatively soft segments transition from relatively brittle (due to heat treatment) to relatively ductile behavior (with more heat treatment), thus enabling them to undergo plastic deformation instead of fracturing. They also have better impact resistance which is to be expected. However, as they undergo this plastic deformation, they also become harder (as expected from steel alloys). But his only happens at critical locations where stress is high. This can be interpreted as a form a selective strain hardening, making the segments harder only where needed and keeping them ductile everywhere else to prevent crack propagation. Also, even at a nominal 42-45 HRC, the gripping teeth have been found to be sufficiently hard to penetrate ductile iron. In experimental testing, data was obtained looking at different hardness segments of two 420 stainless steel MIM sources. One was from Tundra®, of the type previously described, and one was from BASF® which has been commercially available for several years. The BASF® material used in one case was a Catamold® feedstock as described in the publication “Catamold® Feedstock for Metal Injection Molding: Processing-Properties-Applications”, Technical Information BASF, release May 2023, as well as other publications.

Sure-Stop teeth were made with both types of 420 Stainless Steel MIM, the teeth being made in hardness ranges of 34-37, 38-41, 42-45, 46-49 and 49-53 HRC for Tundra® and 42-45 and 49-53 HRC for the BASF® material.

In one exemplary run, parts were made as follows:
420 MIM SST Lot #21153-2011
Austenitize 1950°, hold 2 hrs, temper 300° F., deep freeze −100° F. or lower, temper HRC 42-45
Terramix Sure Stop 8″-12″
420 MIM SST Lot #21153-2011
Austenitize 1950° F., hold 2 hrs, temper 300° F., deep freeze −100° F. or lower, temper HRC 42-45

These teeth were then tested with a load-deflection test, both axial on the 1^{st} tooth and radially on two teeth with up to 20,000 lb of compressive force on the one or two teeth. The data obtained clearly showed that the result is not material dependent, but is hardness dependent. All of the commercial specifications for pipe restraint joint gaskets call for 49+/−4 Rockwell C for the gripping segments that are cold drawn. By using the MIM process steps of the invention, it has been shown that it is possible to make successful segments if the hardness is less than 45 HRC, preferably in the range from about 34-45 HRC, most preferably 42-45 HRC. All previous attempts at using MIM techniques had failed, because the teeth that were manufactured were made at higher hardness and showed brittle failure modes.

Using the methodology of the present invention, it has been show that it is possible to use MIM segments with a lower Rockwell Hardness, allowing a shift from the transition from brittle to ductile failure with the larger crystals that comprise MIM versus cold drawn. This data is also consistent with cyclic testing which has been done in cycling a pipe joint from 0 to 350 psi every seconds with a 12″ Sure-Stop restrained gasket, as shown in Table I:

TABLE I

| Segment | Cycle Count | Average Cycle |
|---|---|---|
| Hardness | at Failure | Count at Failure |
| 42-45 | 25481, 25481, | 25481 |
| | currently Active | |
| 46-49 | 3393, 1748 | 2570 |
| 49-53 | 447, 780 | 613 |

An invention has been provided with several advantages. The techniques of the invention allow for the fabrication of high quality, durable, flexible, strong joint restraint structures, with different types of inserts, for example heavy, dense hard grip rings or dense, hard, serrated joint inserts for pipeline joints, at lower cost than cold drawn materials, and with complex shapes that are not possible with cold drawn martensitic stainless steels.

The newly described techniques can be used to produce whole gaskets, both with large metallic ring inserts as well as with smaller serrated structures for internal joint systems in pipeline applications, as encountered in industries such as the waterworks industry or the oil and gas industry. The techniques can also be used to produce discrete gripping elements for use in various other types of restraint systems. The techniques of the invention allow the creation of heavier structures with better dimension control, density and structural properties' control than the current state of the art. The selective hardening techniques employed result in gripping teeth which are resistant to fracture at loadings which resulted in failure of teeth made with previously used MIM techniques.

What is claimed is:

1. A method for manufacturing a hardened gripping element for a sealing and restraint system used for forming a pipe joint in a fluid pipeline, the method comprising the steps of:
providing a starting material comprised of a metal particulate and polymer composite material;
forming a green metal composite article by either extruding the starting material or molding the starting material into a metal polymer composite article having at least one gripping surface having a plurality of gripping teeth;
thermally or catalytically debinding and sintering the green metal composite article to produce a brown part;
selectively hardening the brown part to a final Rockwell hardness in the range from about 34 HRC to 45 HRC to thereby produce a finished or near finished hardened gripping element.

2. The method of claim 1, wherein the metal composite body is formed by an extrusion process at a suitable temperature and shear rate to form an extruded metal composite body having a required density and shrinkage characteristics.

3. The method of claim 1, wherein the metal composite body is formed by molding using either a compression molding or injection molding process.

4. The method of claim 1, wherein the metal particulate comprise particles of stainless steel and the polymer is comprised of a polyolefin polymer.

5. The method of claim 4, wherein the metal particulate phase makes up greater than about 80% by weight of the particulate mix.

6. A method for manufacturing a hardened gripping element for a sealing and restraint system used for forming a pipe joint in a fluid pipeline, the method comprising the steps of:
providing a starting material comprised of an interfacially modified particulate and polymer composite material, the starting material comprising a metal particulate phase and a polymer phase;
creating a three dimensional printed metallic mold of the gripping element that is to be manufactured, or machining the mold from tool steel;
forming a green metal composite article by injection molding the starting material mix in an injection molding machine into the three dimensional metallic mold to thereby form a metal polymer composite article having at least one gripping surface having a plurality of gripping teeth;
thermally or catalytically debinding and sintering the green metal composite article to produce a brown part;
selectively hardening the brown part to a final Rockwell hardness in a preferred range from about 42 HRC to 45 HRC to thereby produce a finished or near finished hardened gripping element; and
finish machining the hardened gripping element to form a finished hardened gripping element.

7. The method of claim 6, wherein the metal particulate phase is made up of stainless steel particles.

8. The method of claim 6, wherein the polymer phase is a polyolefin polymer, or other catalytically debindable polymer.

9. The method of claim 6, wherein the particulate phase makes up at least about 80% by weight of the metal polymer composite mix.

10. A method forming a sealed and restrained pipe joint between two sections of plastic pipe in a fluid pipeline, the method comprising the steps of:
providing a starting material comprised of a stainless steel particulate and polymer composite material;
creating a three dimensional printed metallic mold of the gripping element that is to be manufactured;
forming a green metal composite article by injection molding the starting material mix in an injection molding machine into the three dimensional metallic mold to thereby form a metal polymer composite article having at least one gripping surface having a plurality of gripping teeth;
thermally or catalytically debinding and sintering the green metal composite article to produce a brown part;
selectively hardening the brown part to a final Rockwell hardness in a preferred range from about 42 HRC to 45 HRC to thereby produce a finished or near finished hardened gripping element;
if necessary, finish machining the near finished gripping element to produce a finished element;
incorporating the finished metal composite article into a sealing and restraint system where the metal composite article is paired with a sealing gasket to thereby form a sealing and restraint system;
installing the sealing and restraint system into a mouth region of a section of belled plastic pipe or fitting, ductile iron pipe or ductile iron fitting;
installing a male pipe end into the mouth region of the section of belled plastic pipe or ductile iron pipe or fitting to thereby form a sealed and restrained pipe joint.

11. The method of claim 10, wherein the particles are formed of stainless steel and the polymer phase is comprised of a polyolefin polymer.
